(19) United States
(12) Patent Application Publication
(10) Pub. No.: US 2022/0189195 A1
(43) Pub. Date: Jun. 16, 2022

(54) METHODS AND APPARATUS FOR AUTOMATIC HAND POSE ESTIMATION USING MACHINE LEARNING

(71) Applicant: DIGITRACK LLC, Boynton Beach, FL (US)

(72) Inventors: Amy KABARIA, Chicago, IL (US); Ravi VIRADIA, Chattanooga, TN (US)

(73) Assignee: DIGITRACK LLC, Boynton Beach, FL (US)

(21) Appl. No.: 17/551,662

(22) Filed: Dec. 15, 2021

Related U.S. Application Data
(60) Provisional application No. 63/125,475, filed on Dec. 15, 2020.

(51) Int. Cl. G06V 40/10; G06V 10/75; G06T 7/00; G06T 7/50; G06T 7/73; G06N 20/00

(52) U.S. Cl. CPC G06V 40/11; G06V 10/757; G06T 7/0012; G06T 2207/20081; G06T 7/75; G06N 20/00; G06T 2207/10028; G06T 7/50

(57) ABSTRACT

Systems and methods for hand pose estimation are provided. For example, a computing device may obtain an image, such as an image of a hand. The computing device may apply one or more preprocessing processes to the image to generate an augmented image. Further, the computing device may apply a first machine learning process to the augmented image to generate a plurality of keypoints. The computing device may also apply a second machine learning process to the plurality of keypoints to generate a plurality of depth values. The computing device may further determine a plurality of angles based on the plurality of keypoints and the plurality of depth values. In some examples, the computing device may generate a model comprising a plurality of segments based on the plurality of angles. The computing device may store the plurality of angles and, in some examples, the model in a memory device.

### CROSS-REFERENCE TO RELATED APPLICATIONS

This application claims priority to U.S. Provisional Application Ser. No. 63/125,475 filed on Dec. 15, 2020 and entitled “METHODS AND APPARATUS FOR AUTOMATIC HAND POSE ESTIMATION USING MACHINE LEARNING,” the content of which is hereby incorporated by reference in its entirety.

### FIELD OF THE INVENTION

The disclosure relates generally to medical analysis systems and, more particularly, to automatically estimating hand poses using machine learning techniques.

### BACKGROUND

Medical professionals, such as orthopedic doctors, currently use handheld tools, such as goniometers, to measure joint angles of patients. For example, when taking joint angle measurements of the patient's hand, the medical professional applies the tool to each joint of each finger of the hand. The measured joint angles allows the medical professional to determine a range of motion of the joint, for example. These methods, however, require in-person visits with the medical professional, which may be inconvenient to the patient and the medical professional. Moreover, while telemedicine systems are available that allow a medical professional to interact with a patient, they are deficient in providing hand pose estimation capabilities that allow a medical professional to sufficiently assess joint angles.

### SUMMARY

The embodiments, in some examples, employ processes, such as machine learning processes, that operate on image data to generate a model of bone structure, such as a model of a person's hand. The embodiments may generate keypoints identifying joints, determines a depth of the keypoints, and determines angles of the joints based on the location of the keypoints and the depths. The embodiments may generate the model based on the joint angles, the keypoints, and the depths. The model may be, for example, a three dimensional (3D) model of the bone structure.

For example, in some embodiments, a computing device receives an image of a hand. The image may have been captured by a personal device of a patient, such as a cellular phone with a camera, for example. The computing device preprocesses the image, such as by applying one or more of color jitter, blurring, black and white, flip, resize, shift, or zoom processes to the image. The computing device generates keypoints based on applying a first machine learning process to the preprocessed image. For example, the computing device may apply a trained convolutional neural network to the preprocessed image to generate the keypoints. Each keypoint may be associated with a location within the preprocessed image, such as a location of the preprocessed image defined by an x and y coordinate (e.g., 2 dimensional keypoint vector).

Further, the computing device applies a second machine learning processes to the generated keypoints to a generate depth value for each keypoint. For example, the computing device may apply a second trained convolutional neural network to the keypoints to generate the depth values. In some examples, the second trained convolutional neural network generates the depth values by identifying a first keypoint closest to the foreground of the image, and generates depth values for the remaining keypoints based on the closest keypoint. The computing device then determines the joint angles based on the keypoints and corresponding depth values. For example, the computing device may apply one or more algorithms to the keypoints (e.g., keypoint vectors) and depth values to determine the joint angles.

The computing device may generate the model of the hand based on the joint angles and keypoints. In some examples, the model of the hand identifies the joint angles. In some examples, the computing device generates the model of the hand based on the joint angles, keypoints, and depth values. For example, the model may identify depth of the joint angles based on the depth values. The computing device may provide the model of the hand for display. For example, the model may be displayed to a medical professional, such as an orthopedic, for assessment. In some examples, the model of the hand is transmitted another computing device, such as to a computing device of the medical professional. In some examples, the computing device overlays the image of the hand with the model of the hand.

In some embodiments, a system includes a memory device, and a computing device communicatively coupled to the memory device. The computing device is configured to obtain an image, and apply one or more preprocessing processes to the image to generate an augmented image. The computing device is also configured to apply a first machine learning process to the augmented image to generate a plurality of keypoints. Further, the computing device is configured to apply a second machine learning process to the plurality of keypoints to generate a plurality of depth values. The computing device is also configured to determine a plurality of angles based on the plurality of keypoints and the plurality of depth values. The computing device is further configured to store the plurality of angles in the memory device.

In some embodiments, a method by a computing device includes obtaining an image, and applying one or more preprocessing processes to the image to generate an augmented image. The method also includes applying a first machine learning process to the augmented image to generate a plurality of keypoints. Further, the method includes applying a second machine learning process to the plurality of keypoints to generate a plurality of depth values. The method also includes determining a plurality of angles based on the plurality of keypoints and the plurality of depth values. The method further includes storing the plurality of angles in a memory device.

In some embodiments, a non-transitory computer readable medium has instructions stored thereon. The instructions, when executed by at least one processor, cause a device to perform operations. The operations include obtaining an image, and applying one or more preprocessing processes to the image to generate an augmented image. The operations also include applying a first machine learning process to the augmented image to generate a plurality of keypoints. Further, the operations include applying a second machine learning process to the plurality of keypoints to generate a plurality of depth values. The operations also include determining a plurality of angles based on the plurality of keypoints and the plurality of depth values. The operations further include storing the plurality of angles in a memory device.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates a hand pose estimation system, in accordance with some embodiments;

FIG. 2 illustrates a computing device, in accordance with some embodiments;

FIG. 3 illustrates portions of the hand pose estimation system of FIG. 1, in accordance with some embodiments;

FIG. 4A illustrates messaging within the hand pose estimation system of FIG. 1, in accordance with some embodiments;

FIG. 4B illustrates a hand pose model, in accordance with some embodiments;

FIG. 5 illustrates exemplary portions of a depth generation engine, in accordance with some embodiments;

FIG. 6 illustrates a model that illustrates the computation of keypoint distances, in accordance with some embodiments;

FIG. 7 illustrates a mapping of a the hand pose model of FIG. 4B over an image of a hand, in accordance with some embodiments;

FIG. 8 illustrates a keypoint map, in accordance with some embodiments;

FIG. 9 illustrates a flowchart of an exemplary method to determine segment attribute values, in accordance with some embodiments; and

FIG. 10 illustrates a flowchart of an exemplary method to determine segment values, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Among other advantages, the embodiments may provide flexibility measurements, such as for joints and wrists, through machine learning processes that operate on still images and video without the need to visit a medical professional. As such, patient recovery times are reduced, thereby increasing patient satisfaction. Further, the embodiments may allow medical providers and patients to utilize their time and resources more effectively by enabling the use of telehealth for acute injuries, fractures, stiffness, and post-rehab visits. In addition, the embodiments may allow patient information (e.g., measured joint angles) to easily be transferred to a patient's chart, which may be used for medical billing. Further, the embodiments may allow medical professionals to more quickly reference previous patient information to gauge improvement, and allow for escalation or de-escalation of rehab protocols. Similarly, the embodiments may allow patients the ability to track their own progress as well. Persons of ordinary skill in the art having the benefit of these disclosures would recognize additional advantages as well.

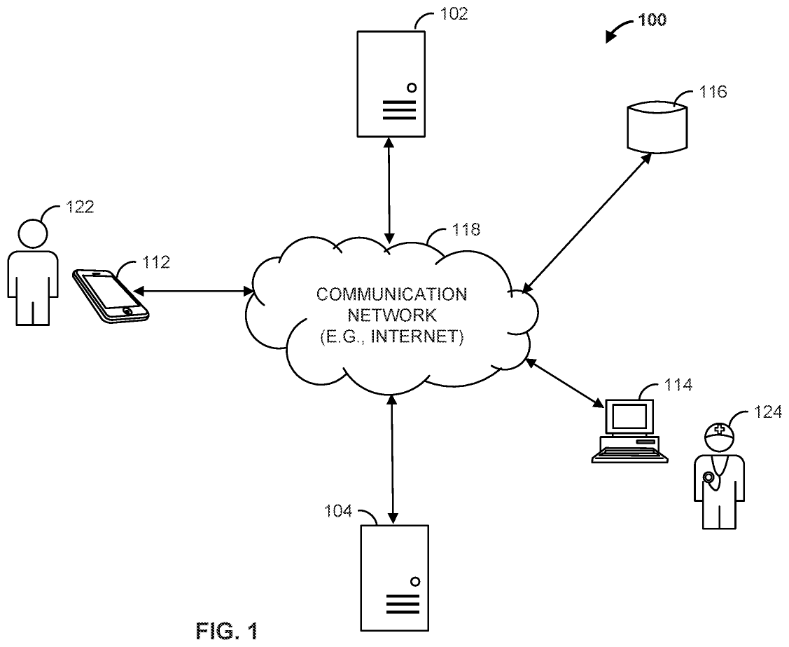

Turning to the drawings, FIG. 1 illustrates a block diagram of a hand pose estimation system 100 that includes a hand pose computing device 102, a web server 104, a medical computing device 114, a patient computing device 112, and a database 116 communicatively coupled over communication network 118. Medical computing device 114 may be operated by a medical professional 124, such as an orthopedic doctor, and patient computing device 112 may be operated by a patient 122, such as a patient of the orthopedic doctor.

Each of hand pose computing device 102, medical computing device 114, and patient computing device 112 may each include any hardware or hardware and software combination that allows for processing data. For example, each can include one or more processors, one or more field-programmable gate arrays (FPGAs), one or more application-specific integrated circuits (ASICs), one or more state machines, digital circuitry, or any other suitable circuitry. For example, each of hand pose computing device 102, medical computing device 114, and patient computing device 112 can be a computer, a workstation, a laptop, a server, or any other suitable computing device. In addition, each can transmit and receive data over communication network 118.

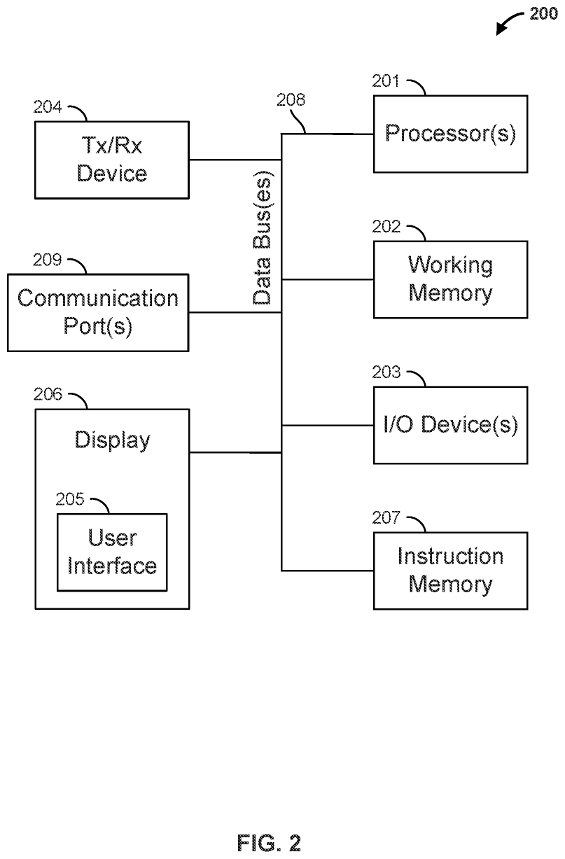

FIG. 2 illustrates an exemplary computing device 200. For example, computing device 200 may be an example of hand pose computing device 102, medical computing device 114, and patient computing device 112. Computing device 200 can include one or more processors 201, working memory 202, one or more input/output (I/O) devices 203, instruction memory 207, a transceiver 204, one or more communication ports 209, a display 206 with a user interface 205, and a global positioning system (GPS) device 211, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of hand pose computing device 102. Working memory 202 can be a random access memory (RAM) such as a static random access memory (SRAM) or dynamic random access memory (DRAM), or any other suitable memory.

I/O devices 203 can include any suitable device that allows for data input or output. For example, I/O devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as patient data.

Display 206 can be any suitable display, and may display user interface 205. User interfaces 205 can enable user interaction with computing device 200. In some examples, a user can interact with user interface 205 by engaging I/O devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. Processor(s) 201 is operable to receive data from, or send data to, a network, such as communication network 118 of FIG. 1, via transceiver 204.

Referring back to FIG. 1, database 116 can be a remote storage device, such as a cloud-based server, a disk (e.g., a hard disk), a memory device on another server, a networked computer, or any other suitable remote storage. Hand pose computing device 102 is operable to communicate with database 116 over communication network 118. For example, hand pose computing device 102 may store data to, or read data from, database 116. Similarly, web server 104, medical computing device 114, and patient computing device 112 may be operable to communicate with database 116 over communication network 118.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, hand pose computing device 102 transmits an image request message to patient computing device 112. In response to receiving the image request message, patient computing device 112 executes an application (e.g., an “App”) that allows patient 122 to capture an image, such as an image of their hand. For example, the application may activate a camera of patient computing device 112. Patient 122 may place their hand in front of the camera and, in response to an input from patient 122, capture an image of the hand. In some examples, the image request message includes hand pose orientation instructions that instruct patient 122 on how to orient their hand when capturing the image.

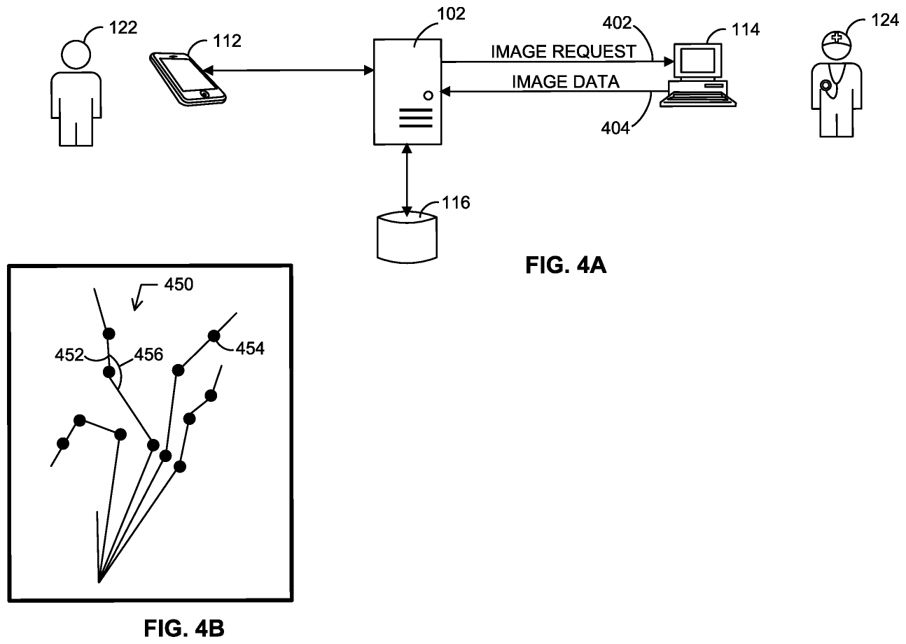

In some examples, the hand pose orientation instructions may include text that is displayed (e.g., via display 206) to patient 122. In some examples, the hand pose orientation instructions may include an orientation image, such as an image illustrating joints of a hand at various angles. Patient computing device 112 may display the orientation image to patient 122, and patient 122 may capture an image of their hand in an orientation in accordance with the orientation image. In some examples, the orientation image may be a hand pose model, such as the hand pose model described below with respect to FIG. 4B.

Further, patient computing device 112 may transmit an image data response message to hand pose computing device 102 in response to the image request message. The image data response message may include the image captured by patient 122. In some examples, the image data response message is encrypted according to any suitable encryption process, such as one using a public and private key. Hand pose computing device 102 may receive the image data response message, and may store the image data response message in database 116.

FIG. 4A, for example, illustrates medical computing device 114 in communication with hand pose computing device 102. Hand pose computing device 102 may host an application that medical computing device 114 accesses via an application programming interface (API), for example. The application may allow for the management of patient data, and communication with one or more patients 122. The application may require that the medical professional 124 provide credential information (e.g., user name and password). Once authenticated, the application allows the medical professional 124 to access patient data and communicate with patients 122. In some examples, hand pose computing device 102 hosts a website. The website may require medical professional 124 to provide credential information. Once authenticated, the website allows the medical professional 124 to access patient data and communicate with patients 122.

The medical professional 124 may provide input (e.g., via I/O device 203) to medical computing device 114 to cause medical computing device 114 to send a message to hand pose computing device 102. In response to receiving the message, hand pose computing device 102 transmits an image request 402 to patient computing device 112. The image request 402 may cause patient computing device 112 to executes the application (e.g., an “App”) that allows patient 122 to capture an image of their hand. In some examples, the image request 402 includes hand pose orientation instructions as described herein. Patient 122 may capture an image of their hand in accordance with the hand pose orientation instructions. Once the image is captured, patient computing device 112 may transmit image data 404 to hand pose computing device 102. The image data 404 may identify and characterize the captured image. Hand pose computing device 102 may store the image data 404 in database 116.

Referring back to FIG. 1, hand pose computing device 102 may determine joint angles of the patient's 122 hand based on the received image. For example, hand pose computing device may apply one or more preprocessing methods (e.g., image data augmentation techniques) to the image. For example, hand pose computing device 102 may apply one or more of color jitter, blurring, black and white, flip, resize, shift, or zoom processes to the image. The preprocessing methods may be configurable by a user, such as by medical professional 124. The preprocessed image may include a plurality of pixels, each pixel at a particular location (e.g., row and height) of the preprocessed image (e.g., x, y coordinates).

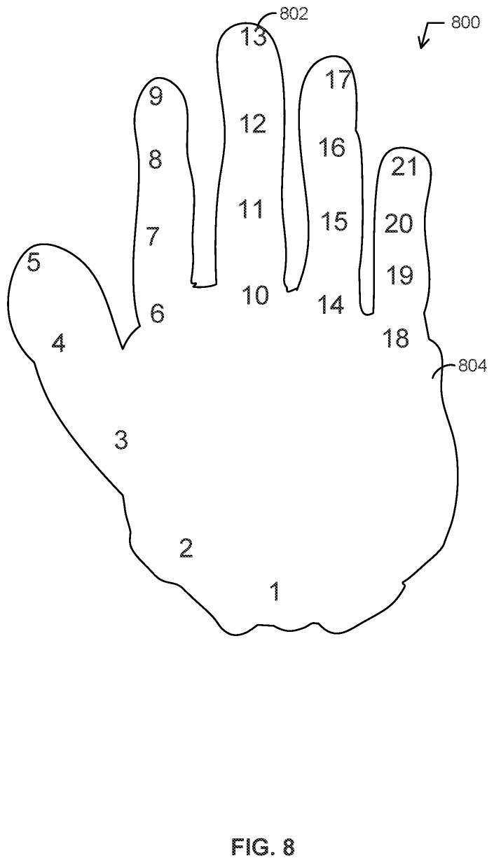

After preprocessing, hand pose computing device 102 may apply a machine learning process (e.g., algorithm) to the preprocessed image to generate keypoints. For example, hand pose computing device 102 may apply a trained convolutional neural network to the preprocessed image to generate the keypoints. The trained convolutional neural network may generate the keypoints using a series of masking on each image to determine both x and y axis data. The x and y data may be overlaid on the image during post processing to visually label each keypoint. Each keypoint may be associated with one or more pixels of the preprocessed image, and may identify the location of the one or more pixels (e.g., defined by x and y coordinates corresponding to the preprocessed image). The keypoints may identify one or more joints in the preprocessed image. For example, FIG. 8 illustrates a keypoint map 800 that identifies keypoints 802 of a hand 804. Hand pose computing device 102 may identify one or more of the keypoints 802 as joints of hand 810. Referring back to FIG. 1, hand pose computing device 102 may represent the generated keypoints as a keypoint vector, such as a two-dimensional vector (e.g., keypoints[ ][ ]), and store the keypoint vector in database 116.

Further, hand pose computing device 102 may apply a second machine learning process to the keypoints to generate depth values for each image pixel. For example, hand pose computing device 102 may apply a second trained convolutional neural network to the keypoints to generate the depth values. The second trained convolutional neural network may include, for example, eight layers. Incorporating eight layers instead of, for example, seven layers allows the convolutional neural network to operate on additional features.

In some examples, the second trained convolutional neural network generates the depth values by identifying a first keypoint closest to the foreground of the image. The first keypoint may be determined using a series of masking over each image to determine which range of pixels are closest (and furthest away) from the camera's point of view. The second trained convolutional neural network may assign the closest keypoint a depth value (e.g., 1). Further, the second trained convolutional neural network may determine a depth value for each of the remaining keypoints based on the closest keypoint. Each of the depth values may be, for example, a ratio, where each ratio identifies a “depth distance” from the closest keypoint to the corresponding keypoint.

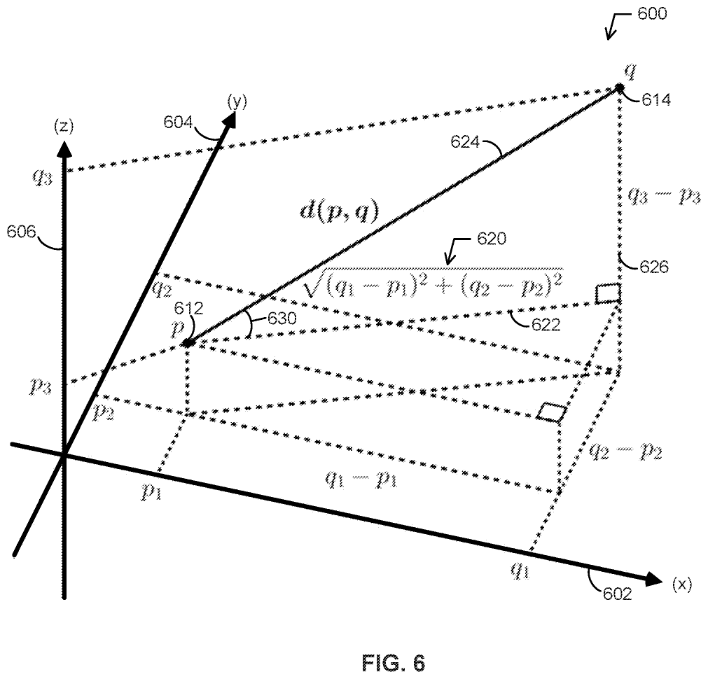

Hand pose computing device 102 may then determine joint angles based on the keypoints and corresponding depth values. For example, hand pose computing device 102 may apply one or more algorithms to the keypoints (e.g., keypoint vectors) and depth values to determine the joint angles. As an example, hand pose computing device 102 may employ a Euclidean Distance algorithm to determine distances between keypoints. For example, FIG. 6 illustrates a model 600 that includes an x-axis 602, y-axis 604, and z-axis 606. Keypoint p 612 is at coordinate (p₁, p₂, p₃), and keypoint q 614 is at coordinate (q₁, q₂, q₃). Euclidian distance equation 620 in this example illustrates the computation of a first keypoint distance 622 between keypoint p 612 and keypoint q 614 along the x-axis 602 and y-axis 604 plane. Similarly, second keypoint distance 624 may be computed based on applying a Euclidian distance equation to first keypoint distance 622 and third keypoint distance 626. Based on the computed keypoint distances, hand pose computing device 102 may determine angles, such as angle 630, which is an angle along the z-axis 606 with respect to the x-axis 602 and y-axis 604 plane. For example, hand pose computing device 102 may apply known algebraic equations that operate on the lengths of two sides of a triangle to determine an angle between the sides. An angle between keypoints (e.g., which correspond to joint locations) may identify a joint angle.

Referring back to FIG. 1, hand pose computing device 102 may generate a model of the hand based on the joint angles and keypoints. For example, hand pose computing device 102 may generate an image that includes segments between the keypoints that represent joints, with the segments oriented in accordance with the corresponding joint angle. FIG. 4B illustrates an exemplary hand pose model 450 that includes a plurality of segments 452 between keypoints 454. Angles 456 are defined between segments 452. In some examples, the model includes text identifying the joint angles. For example, hand pose model 450 may include text near each angle 456 identifying an angle value (e.g., 0° to 180°).

In some examples, hand pose computing device 102 overlays the model over the image received from patient computing device 112. Hand pose computing device 102 may overlay the model based on corresponding pixel locations. For example, hand pose computing device 102 may overlay a model pixel located at coordinate (0,0) over the received image pixel at coordinate (0,0), such as when the resolution of the received image and the model are the same. In some examples, hand pose computing device 102 may resize the model and/or the received image to align the model and received image. In some examples, the model is transparent, such that the image of the hand may be seen through the portions of the generated model including segments and keypoints.

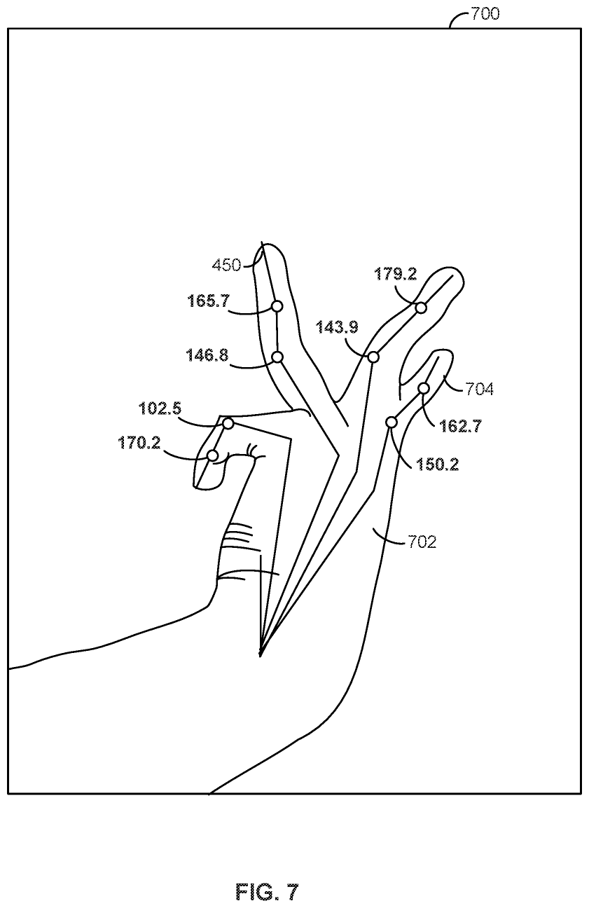

For example, FIG. 7 illustrates an overlaid image 700 that includes the hand pose model 450 of FIG. 4B overlaid over a hand image 702. Hand image 702 may have been captured by patient computing device 112. In this example, overlaid image 700 includes joint angles 704 (e.g., text identifying a value of joint angle), which may assist medical professional 124 in assessing the state or progress of the patient's 122 hand.

In some examples, hand pose computing device 102 transmits the model to medical computing device 114. Further, medical computing device 114 may display the received model to medical professional 124. As such, medical professional 124 may assess the image, and determine patient's 122 progress, such as progress from a hand injury.

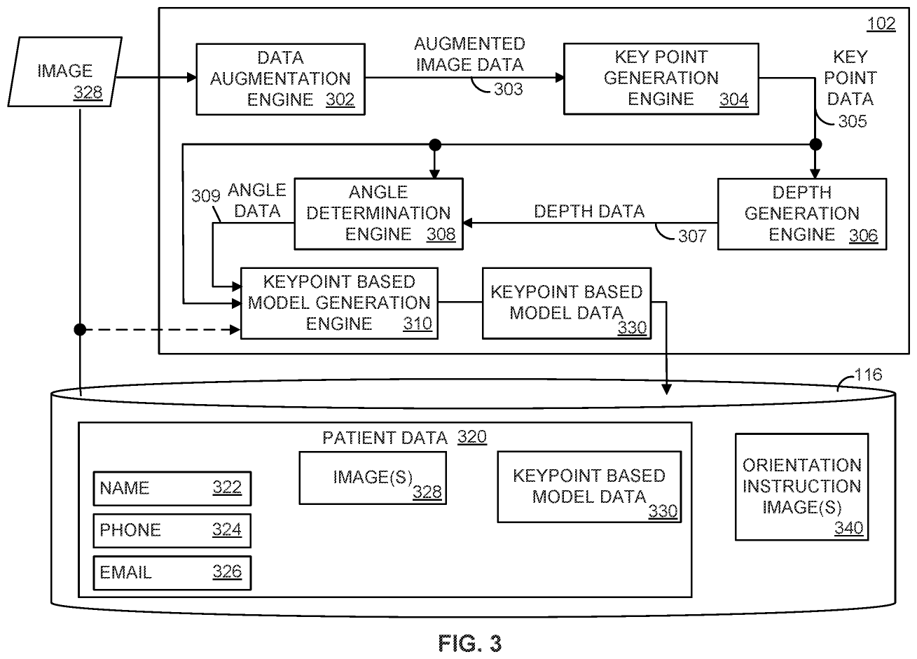

FIG. 3 illustrates exemplary portions of the hand pose estimation system 100 of FIG. 1. In this example, hand pose computing device 102 includes data augmentation engine 302, keypoint generation engine 304, depth generation engine 306, angle determination engine 308, and keypoint based model generation engine 310. In some examples, one or more of data augmentation engine 302, keypoint generation engine 304, depth generation engine 306, angle determination engine 308, and keypoint based model generation engine 310 may be implemented hardware. In some examples, one or more of data augmentation engine 302, keypoint generation engine 304, depth generation engine 306, angle determination engine 308, and keypoint based model generation engine 310 may be implemented as an executable program maintained in a tangible, non-transitory memory, such as instruction memory 207 of FIG. 2, that may be executed by one or processors, such as processor 201 of FIG. 2.

In this example, database 116 stores patient data 320. Patient data 320 may include, for each patient 122, a name 322, a phone number 324, and an email address 326. Patient data 320 may also include, for each patient 122, one or more images 328. Each image 328 may be captured by patient computing device 112 for a patient 122 as described herein, and stored in database 116 within patient data 320 corresponding to the patient 122.

Data augmentation engine 302 obtains image 328 for a patient 122, and preprocesses the image 328. For example, data augmentation engine 302 may apply one or more of color jitter, blurring, black and white, flip, resize, shift, or zoom processes to image 328. Data augmentation engine 302 generates augmented image data 303 identifying and characterizing the preprocessed image 328, and provides augmented image data 303 to keypoint generation engine 304.

Keypoint generation engine 304 may generate keypoint data 305 identifying and characterizing one or more keypoints based on augmented image data 303. For example, keypoint generation engine 304 may apply a trained convolutional neural network to the preprocessed image to generate the keypoints. Each keypoint may be associated with one or more pixels of augmented image data 303, and may identify the location of the one or more pixels. Each keypoint may identify one or more joints of augmented image data, for example. In some examples, keypoint data 305 is a keypoint vector.

Depth generation engine 306 obtains the keypoint data 305 and generates depth values based on keypoint data 305. For example, depth generation engine 306 may apply a trained convolutional neural network to keypoint data 305 to generate the depth values. The second trained convolutional neural network may include, for example, eight layers. In some examples, the second trained convolutional neural network generates the depth values by identifying a first keypoint closest to the foreground of the image, and identifies a depth ratio for each keypoint based on the first keypoint. Depth generation engine 306 may generate depth data 307 identifying and characterizing the depth ratios.

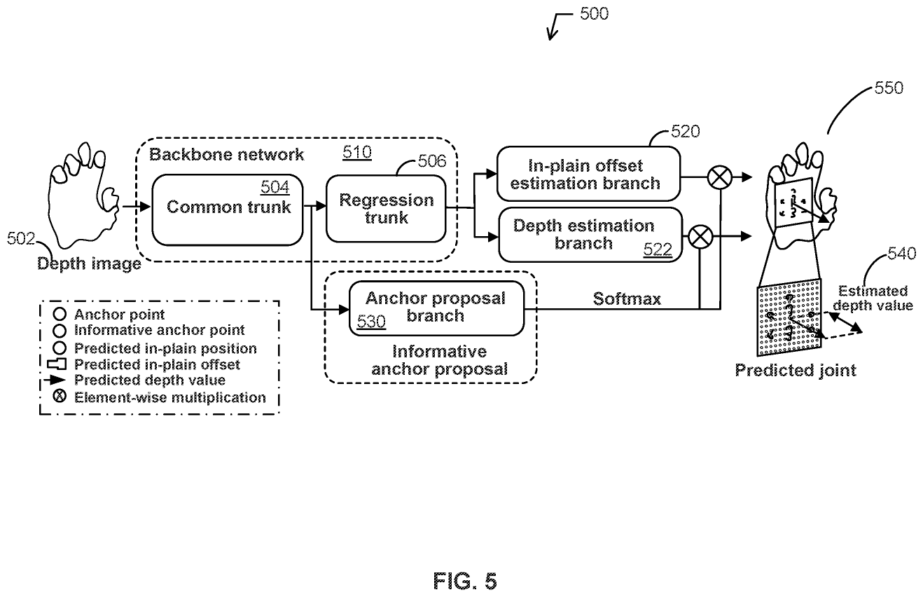

FIG. 5 illustrates exemplary portions of a depth generation engine 500, such as depth generation engine 306. Depth generation engine 306 may include a backbone network 510 (e.g., classifier) that includes a common trunk 504 and a regression trunk 506, where the common trunk 504 receives depth image 502. Depth image 502 may be represented as a scalar value per pixel of the image, for example. Regression trunk 506 may apply a trained convolutional neural network to an output of the common trunk 504. Depth generation engine 500 also includes an in-plain offset estimation branch 520 and a depth estimation branch 522, each of which receive the output of the regression trunk 506. Depth estimation branch 522 may compute a scalar value representing an estimated depth. Further, depth generation engine 500 includes an anchor proposal branch 530 that receives the output from the common trunk 504. The anchor proposal branch 530 employs a softmax activation function on the output of the depth estimation branch 522. The output of the in-plain offset estimation branch 520 is multiplied with an output of the anchor proposal branch 530 and, similarly, the output of the depth estimation branch 522 is multiplied with an output of the anchor proposal branch 530, to generate an estimated depth value 540 of a predicted joint 550.

Referring back to FIG. 3, angle determination engine 308 obtains depth data 307 from depth generation engine 306 and keypoint data 305 from keypoint generation engine 304. Angle determination engine 308 determines angles (e.g., joint angles) based on keypoint data 305 and depth data. For example, angle determination engine 308 ma determine an angle for each keypoint identified by keypoint data 305 based on the location of each keypoint within augmented image data 303 (e.g., x, y coordinate) and its corresponding depth value. In some examples, angle determination engine 308 applies one or more algorithms, such as a Euclidean Distance algorithm, to determine distances between keypoints, and determines the angles based on the determined distances. Angle determination engine 308 generates angle data 309 identifying the angles, and provides angle data 309 to keypoint based model generation engine 310.

Keypoint based model generation engine 310 generates a model based on angle data 309 and keypoint data 305. For example, keypoint based model generation engine 310 may generate an image that includes segments (e.g., segments 452) between the keypoints (e.g., keypoints 454) that represent joints, with the segments oriented in accordance with the corresponding joint angle.

In some examples, keypoint based model generation engine 310 overlays the model over image 328 to generate an overlaid image (e.g., overlaid image 700). Keypoint based model generation engine 310 may overlay the model based on corresponding pixel locations. In some examples, keypoint based model generation engine 310 resizes the model and/or image 328 to align the model and image 328. In some examples, the model is transparent, such that the image of the hand may be seen through the portions of the generated model including segments and keypoints. Keypoint based model generation engine 310 generates keypoint based model data 330 identifying and characterizing the generated model, and stores keypoint based model data 330 in database 116.

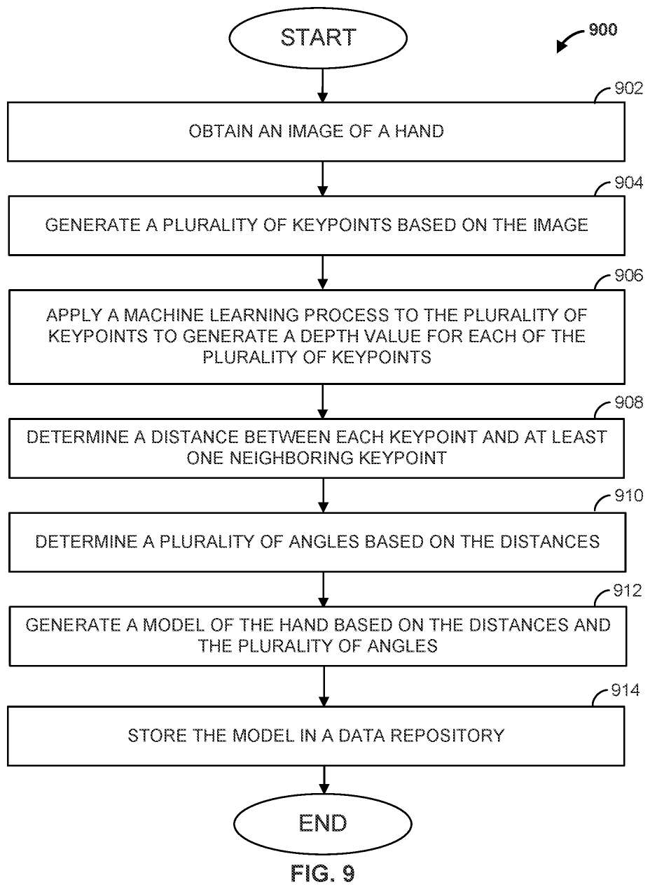

FIG. 9 illustrates a flowchart of an exemplary method 900 that can be carried out by a computing device such as, for example, hand pose computing device 102. Beginning at step 902, an image of a hand is obtained. For example, hand pose computing device 102 may obtain an image 328 for a patient 122. At step 904, a plurality of keypoints are generated based on the image. For example, hand pose computing device 102 may apply a trained machine learning process to the image to generate the keypoints. The keypoints may correspond to one or more keypoints of a keypoint map, such as keypoint map 800.

Proceeding to step 906, a machine learning process is applied to the plurality of keypoints to generate a depth value for each of the plurality of keypoints. For example, hand pose computing device 102 may apply a trained convolutional neural network to the plurality of keypoints to generate the depth values. At step 908, a distance between each of the plurality of keypoints and at least one neighboring keypoint is determined. For example, hand pose computing device 102 may apply a Euclidian distance equation to the keypoints to determine the distances.

At step 910, a plurality of angles are determined based on the distances. For example, hand pose computing device 102 may apply known algebraic equations that operate on distances to determine the plurality of angles. At step 912, a model of the hand is generated based on the distances and the plurality of angles. For example, hand pose computing device 102 may generate a model, such as hand pose model 450, that identifies a plurality of segments (e.g., segments 452) between keypoints (e.g., keypoints 454). The segments are angled based on the plurality of angles (e.g., angles 456). For example, each angle may correspond to an angle between segments, where each segment is between two keypoints, for example. In some examples, the model identifies the angles. For example, the model may include text identifying a value of each joint angle (e.g., joint angles 704).

At step 914, the model is stored in a data repository. For example, hand pose computing device 102 may store the model in database 116. In some examples, hand pose computing device 102 transmits the model to medical computing device 114. The method then ends.

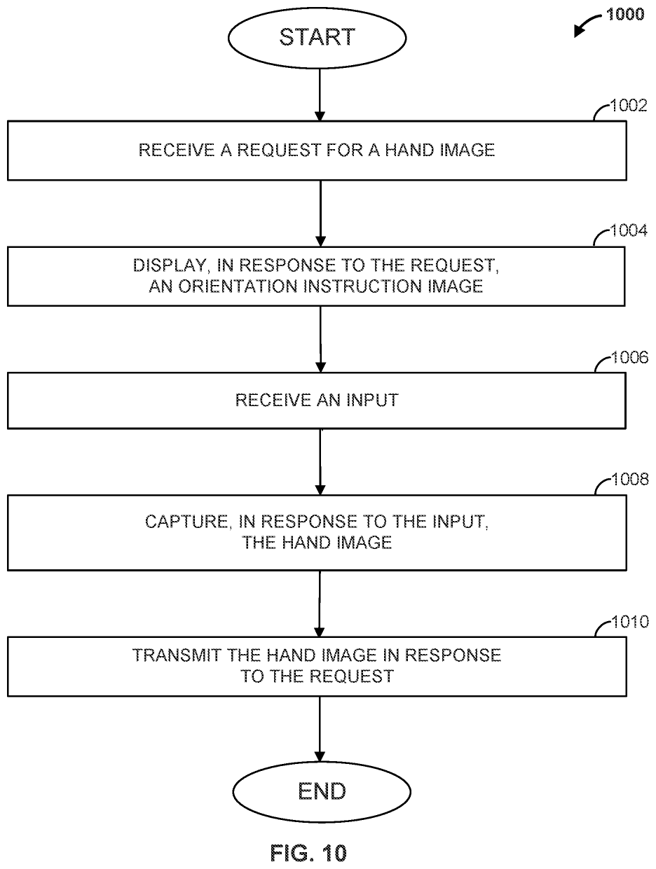

FIG. 10 illustrates a flowchart of an exemplary method 1000 that can be carried out by a computing device such as, for example, patient computing device 112. Beginning at step 1002, a request for a hand image is received. For example, patient computing device 112 may receive an image request 402 from hand pose computing device 102. The image request may be sent in response to a message received by hand pose computing device 102 from medical computing device 114. At step 1004, in response to the request, an orientation instruction image is displayed. For example, image request 402 may include an image of a hand orientation, such as hand pose model 450. Patient computing device 112 may display (e.g., via display 206) to patient 122 the hand pose model 450.

Proceeding to step 1006, an input is received. For example, patient computing device 112 may receive, via I/O device 203, an input from patient 122. At step 1008, in response to the image, the hand image is captured. For example, patient 122 may place a hand in from of a camera of patient computing device 112, and provide the input. In response to the input, an application executed by patient computing device 112 may cause a camera to capture an image of the patient's 112 hand. At step 1010, the hand image is transmitted in response to the request. For example, patient computing device 112 may transmit image data 404 identifying and characterizing the captured image to hand pose computing device 102. In some examples, hand pose computing device 102 stores the image data 404 in database 116. The method then ends.

In some examples, a system includes a memory device and a computing device (e.g., hand pose computing device 102). The computing device is communicatively coupled to the memory device, and is configured to obtain an image. The image may be obtained from the memory device, for example. The computing device is also configured to apply one or more preprocessing processes to the image to generate an augmented image. Further, the computing device is configured to apply a first machine learning process to the augmented image to generate a plurality of keypoints. The computing device is also configured to apply a second machine learning process to the plurality of keypoints to generate a plurality of depth values. Further, the computing device is configured to determine a plurality of angles based on the plurality of keypoints and the plurality of depth values. The computing device is also configured to store the plurality of angles in the memory device.

In some examples, the computing device is further configured to generate a model including a plurality of segments, where the plurality of segments are oriented based on the plurality of angles. The computing device is also configure to store the model in the memory device.

In some examples, a system includes a memory device and a computing device (e.g., patient computing device 112). The computing device is communicatively coupled to the memory device, and is configured to transmit a request to a second computing device including an orientation image. The request causes the second computing device to display the orientation image. Further, the computing device is configured to receive, in response to the request, a captured image, where the captured image was captured by the second computing device. The computing device is further configure to store the captured image in the memory device.

In some examples, a method by a computing device (e.g., hand pose computing device 102) includes obtaining an image. The method also includes applying one or more preprocessing processes to the image to generate an augmented image. Further, the method includes applying a first machine learning process to the augmented image to generate a plurality of keypoints. The method also includes applying a second machine learning process to the plurality of keypoints to generate a plurality of depth values. The method further includes determining a plurality of angles based on the plurality of keypoints and the plurality of depth values. The method also includes storing the plurality of angles in a memory device.

In some examples, the method further includes generating a model including a plurality of segments, where the plurality of segments are oriented based on the plurality of angles. The method also includes storing the model in the memory device.

In some examples, a method by a computing device (e.g., patient computing device 112) includes transmitting a request to a second computing device comprising an orientation image, wherein the request causes the second computing device to display the orientation image. The method may also include receiving, in response to the request, a captured image, wherein the captured image was captured by the second computing device. Further, the method includes storing the captured image in a memory device.

In some examples, a non-transitory computer readable medium has instructions stored thereon, where the instructions, when executed by at least one processor, causes a device (e.g., hand pose computing device 102) to perform operations. The operations include obtaining an image. The operations also include applying one or more preprocessing processes to the image to generate an augmented image. Further, the operations include applying a first machine learning process to the augmented image to generate a plurality of keypoints. The operations also include applying a second machine learning process to the plurality of keypoints to generate a plurality of depth values. The operations further include determining a plurality of angles based on the plurality of keypoints and the plurality of depth values. The operations also include storing the plurality of angles in a memory device.

In some examples, the operations further include generating a model including a plurality of segments, where the plurality of segments are oriented based on the plurality of angles. The operations also include storing the model in the memory device.

In some examples, a non-transitory computer readable medium has instructions stored thereon, where the instructions, when executed by at least one processor, causes a device (e.g., patient computing device 112) to perform operations. The operations include transmitting a request to a second computing device comprising an orientation image, where the request causes the second computing device to display the orientation image. The operations also include receiving, in response to the request, a captured image, wherein the captured image was captured by the second computing device. Further, the operations include storing the captured image in a memory device.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a memory device; and
a computing device communicatively coupled to the memory device, wherein the computing device is configured to:
obtain an image;
apply one or more preprocessing processes to the image to generate an augmented image;
apply a first machine learning process to the augmented image to generate a plurality of keypoints;
apply a second machine learning process to the plurality of keypoints to generate a plurality of depth values;
determine a plurality of angles based on the plurality of keypoints and the plurality of depth values; and
store the plurality of angles in the memory device.

2. The system of claim 1, wherein the computing device is configured to:
generate a model comprising a plurality of segments, wherein the plurality of segments are oriented based on the plurality of angles; and
store the model in the memory device.

3. The system of claim 1, wherein the computing device is configured to:
transmit a request to a second computing device, wherein the request causes the second computing device to display a request to capture an image;
receive, in response to the request, the image; and
store the image in the memory device.

4. The system of claim 3, wherein the request comprises an orientation image comprising joints of a hand at a plurality of angles.

5. The system of claim 3, wherein the request comprises orientation instructions.

6. The system of claim 1, wherein the one or more preprocessing processes comprise at least one of a color jitter, a blurring, a black and white, a flip, a resize, a shift, and a zoom.

7. The system of claim 1, wherein applying the second machine learning process to the plurality of keypoints comprises identifying a first keypoint closest to a foreground of the image, and identifying a depth ratio for each keypoint based on the first keypoint.

8. The system of claim 1, wherein the plurality of keypoints identify a location of one or more pixels of the image.

9. The system of claim 1, wherein determining the plurality of angles comprises determining a plurality of distances between the plurality of keypoints.

10. A method by a computing device comprising:
obtaining an image;
applying one or more preprocessing processes to the image to generate an augmented image;
applying a first machine learning process to the augmented image to generate a plurality of keypoints;
applying a second machine learning process to the plurality of keypoints to generate a plurality of depth values;
determining a plurality of angles based on the plurality of keypoints and the plurality of depth values; and
storing the plurality of angles in a memory device.

11. The method of claim 10, further comprising:
generating a model comprising a plurality of segments, wherein the plurality of segments are oriented based on the plurality of angles; and
storing the model in the memory device.

12. The method of claim 10, further comprising:
transmitting a request to a second computing device, wherein the request causes the second computing device to display a request to capture an image;
receiving, in response to the request, the image; and
storing the image in the memory device.

13. The method of claim 12, wherein the request comprises an orientation image comprising joints of a hand at a plurality of angles.

14. The method of claim 12, wherein the request comprises orientation instructions.

15. The method of claim 10, wherein applying the second machine learning process to the plurality of keypoints comprises identifying a first keypoint closest to a foreground of the image, and identifying a depth ratio for each keypoint based on the first keypoint.

16. The method of claim 10, wherein determining the plurality of angles comprises determining a plurality of distances between the plurality of keypoints.

17. A non-transitory computer readable medium having instructions stored thereon, wherein the instructions, when executed by at least one processor, cause a device to perform operations comprising:
obtaining an image;
applying one or more preprocessing processes to the image to generate an augmented image;
applying a first machine learning process to the augmented image to generate a plurality of keypoints;
applying a second machine learning process to the plurality of keypoints to generate a plurality of depth values;
determining a plurality of angles based on the plurality of keypoints and the plurality of depth values; and
storing the plurality of angles in a memory device.

18. The non-transitory computer readable medium of claim 17, wherein the operations further comprise:
generating a model comprising a plurality of segments, wherein the plurality of segments are oriented based on the plurality of angles; and
storing the model in the memory device.

19. The non-transitory computer readable medium of claim 17, wherein the operations further comprise:
transmitting a request to a second computing device comprising an orientation image, wherein the request causes the second computing device to display the orientation image;
receiving, in response to the request, the image, wherein the image was captured by the second computing device; and
storing the captured image in a memory device.

20. The non-transitory computer readable medium of claim 17, wherein applying the second machine learning process to the plurality of keypoints comprises identifying a first keypoint closest to a foreground of the image, and identifying a depth ratio for each keypoint based on the first keypoint.
